(19) United States
(12) Patent Application Publication
(10) Pub. No.: US 2025/0379895 A1
(43) Pub. Date: Dec. 11, 2025

(54) SYSTEM AND METHOD FOR GRANULAR CONTROL OVER A MULTIMEDIA PRIORITY SERVICE

(71) Applicant: Verizon Patent and Licensing Inc., Basking Ridge, NJ (US)

(72) Inventors: Lixia Yan, Basking Ridge, NJ (US); Violeta Cakulev, Millburn, NJ (US); Sudhakar Reddy Patil, Flower Mound, TX (US); Toby Varughese John, Murphy, TX (US)

(21) Appl. No.: 18/735,007

(22) Filed: Jun. 5, 2024

(51) Int. Cl. H04L 65/1069; H04L 65/1016; H04L 65/1073; H04L 65/80

(52) U.S. Cl. CPC H04L 65/1069; H04L 65/1073; H04L 65/80; H04L 65/1016

(57) ABSTRACT

A device may comprise a processor. The processor may be configured to: receive, from a User Equipment device (UE), a registration request; obtain Multimedia Priority Service (MPS) policy parameters for the UE in response to the registration request; receive, from the UE, a request to establish a session; set a priority of a message to be sent to establish the session, based on the MPS policy parameters; and send the message to establish the session.

### BACKGROUND INFORMATION

The IP Multimedia Subsystem (IMS) refers to an architectural framework designed to deliver multimedia communication services over Internet Protocol (IP) networks. Initially developed by the 3rd Generation Partnership Project (3GPP), IMS evolved as part of mobile networks, such as a Global System for Mobile Communications (GSM) network, to provide services beyond simple voice calls. Its current scope encompasses supporting a wide range of networks, including fixed and mobile broadband networks.

An IMS network may offer a Multimedia Priority Service (MPS). In an MPS, specific types of multimedia traffic are prioritized over other types. For example, an IMS network that implements the MPS may prioritize emergency calls over other types of calls. More generally, an MPS may ensure that critical multimedia communications, such as video calls, audio communications, and data transfers, during highly congested network conditions or during emergencies when network resources are limited, receive higher priority and better quality of service than less critical traffic.

### BRIEF DESCRIPTION OF THE DRAWINGS

FIGS. 1A and 1B illustrate concepts described herein.

FIG. 2 illustrates an exemplary network environment in which systems and methods described herein may be implemented.

FIG. 3 depicts exemplary Fifth Generation (5G) core network components, according to an implementation.

FIG. 4 is a flow diagram of an example process that is associated with granular control over a Multimedia Priority service (MPS), according to an implementation.

FIGS. 5A and 5B illustrate example messages exchanged between network components during a process that is associated with granular control over an MPS, according to an implementation.

FIG. 5C shows example MPS policy parameters, according to an implementation.

FIG. 6 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID).

Systems and methods described herein relate to granular control over Multimedia Priority Service (MPS). Typically, an MPS allows prioritization of Internet Protocol Multimedia Service (IMS)-based calls. The feature allows National Security/Emergency Preparedness users to make calls over a network even when the network is congested, by giving the calls a priority over other calls in the network.

To provide an MPS to calls made from a User Equipment device (UE) (e.g., a smartphone), when the UE registers at a network, the network may retrieve a subscription profile that is associated with the UE and determine whether the UE should receive the MPS based on the subscription profile. If so, the network may flag or mark its control plane communications among its components. Based on the flag, the network may route all the signaling messages from the UE as high priority messages and may establish sessions with the UE as high priority sessions.

In many networks, the above-described mechanism may be inadequate to provide granular control over MPS. More specifically, the mechanism fails to account for an MPS subscriber category to which the UE belongs and a data network (or a network slice) that the UE accesses. For example, a UE may belong to one of many MPS subscriber categories (e.g., emergency, government, utilities, commercial, general public, etc.). However, a network may fail to take the subscriber category of the UE into consideration when assigning a priority to signaling messages associated with the UE. Thus, the network may only assign the priority of 1 (e.g., the highest priority) for UEs that belong to different subscriber categories, although the network may be capable of different priorities (e.g., 5 priorities),

In another example, a UE subscribed to an MPS may establish sessions with a device which does not require a high priority treatment for its traffic. When the UE establishes a session with the device, the network may nonetheless assign a high priority to the session, hence unnecessarily depleting network resources (e.g., bandwidth). The systems and methods described herein address the above-described issues, by assigning transport priorities, to signaling messages associated with UEs subscribed to MPS and to sessions between the UEs and the network, based on the subscriber category and the data network (or the network slice) that the UE may access.

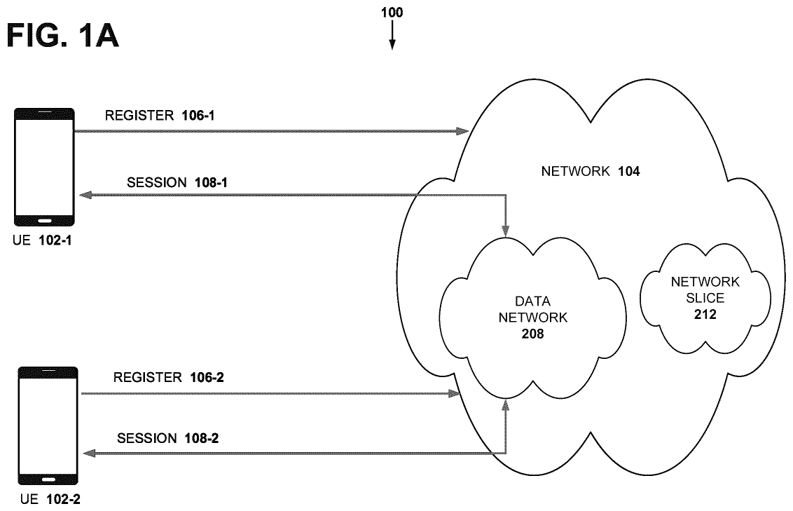

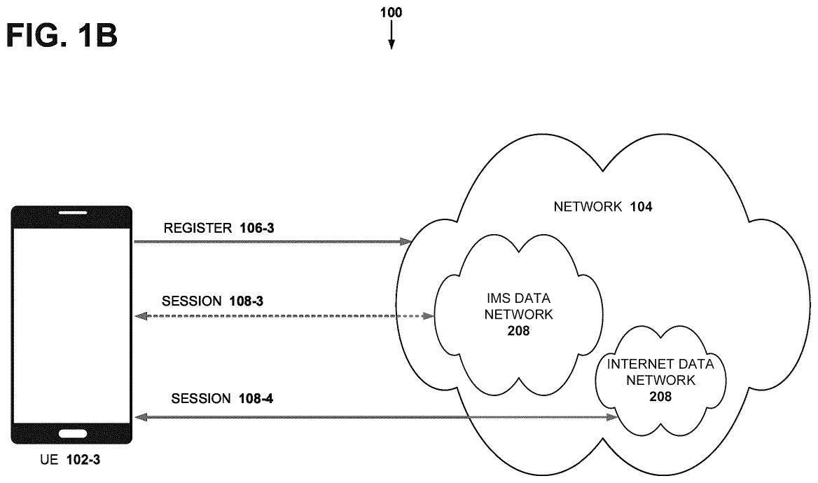

FIGS. 1A and 1B illustrate the concepts described herein. For both FIGS. 1A and 1B, assume provider network 104 includes a system for applying granular control over MPS. For FIG. 1A, assume that UE 102-1 is subscribed to an MPS for the government subscriber category at provider network 104 and UE 102-2 is subscribed to the MPS for a general public subscriber category at provider network 104. As shown, UE 102-1 registers 106-1 at provider network 104. When UE 102-1 establishes a session 108-1 with network 104, the system for granular control over MPS assigns a transport priority level (also simply referred to as transport priority) to session 108-1. Similarly, UE 102-2 registers 106-2 at provider network 104. When UE 102-2 establishes a session 108-2 with data network 208 in network 104, the system assigns a transport priority level to session 108-2. However, because the system takes the subscriber categories for UEs 102-1 and 102-2 into consideration when assigning the transport priority levels, the transport priority levels for sessions 108-1 and 108-2 can be different. Such differentiation enables provider network 104 to allocate network resources for sessions in accordance with the importance of particular UE traffic.

For FIG. 1B, assume that UE 102-3 is subscribed to MPS at provider network 104. As shown, UE 102-3 registers 106-3 at provider network 104. When UE 102-3 establishes a session 108-3 with data network 208 (which may be included in a network slice) in network 104, the system for granular control over MPS assigns a transport priority to session 108-3. After the termination of session 108-3, when UE 102-3 establishes a session 108-4 with network slice 212, the system assigns a transport priority to session 108-4. However, because the system takes the data network 208 and/or network slice 212 into consideration when assigning the transport priorities, the transport priorities for sessions 108-3 and 108-4 can be different. The differentiation enables provider network 104 to allocate an appropriate amount of network resources for each of sessions 108-3 and 108-4.

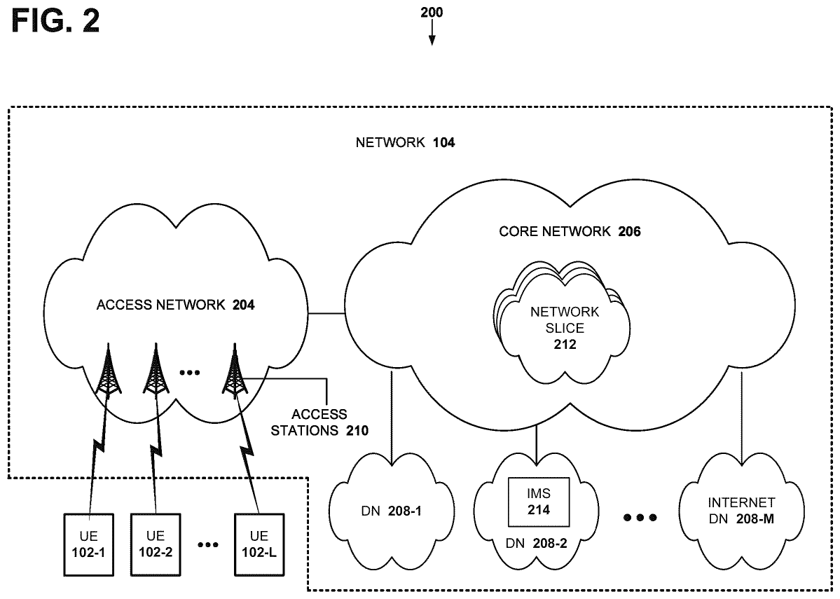

FIG. 2 illustrates an exemplary network environment 200 in which the systems and methods described herein may be implemented. As shown, network environment 200 may include UEs 102-1 through 102-L (collectively referred to as UEs 102 and generically referred to as UE 102), access network 204, core network 206, and data networks (DNS) 208-1 through 208-M (collectively referred to as data networks 208 and generically as data network 208). Access network 204, core network 206, and data networks 208 may be part of provider network 104.

UEs 102 may include a wireless communication device capable of Fourth Generation (4G) (e.g., Long-Term Evolution (LTE)) communication, Fifth Generation (5G) New Radio (NR) communication, and/or other wireless communication. Examples of UE 102 include: a Fixed Wireless Access (FWA) device; a Customer Premises Equipment (CPE) device with 4G and 5G capabilities; a smart phone; a tablet device; a wearable computer device (e.g., a smart watch); a global positioning system (GPS) device; a laptop computer; a media playing device; a portable gaming system; an autonomous vehicle navigation system; a sensor; and an Internet-of-Things (IoT) device. In some implementations, UE 102 may include a wireless Machine-Type-Communication (MTC) device that communicates with other devices over a machine-to-machine (M2M) interface, such as LTE-M or Category M1 (CAT-M1) devices and Narrow Band (NB)-IoT devices.

UEs 102 may be associated with a user that is subscribed to network 104 to receive an MPS. The subscription profile for UE 102, stored at provider network 104, may indicate to which subscriber category the UE 102 belongs (e.g., one of an emergency category, a government category, a utilities category, a commercial category, and a general public category). When UE 102 sends a registration request to network 104, UE 102 may indicate, in the registration request, that the request is for MPS priority access. Consequently, provider network 104 may assign one of many levels of transport priorities to communications associated with UE 102 based on the UE subscriber category.

Access network 204 may facilitate UE 102's connection to core network 206 by establishing and managing over-the-air channels with UE 102 and backhaul channels with core network 206. These channels enable the relay of information between UE 102 and core network 206. Access network 204 comprises LTE, 5G NR, or other advanced radio access networks, featuring components such as central units (CUs), distributed units (DUs), radio units (RUS), and/or base stations. These network components are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., evolved Node B (eNB), next generation Node B (gNB), etc.) that comprises one or more radio frequency (RF) transceivers. In some implementations, access station 210 may be part of an evolved Universal Mobile Telecommunications Service (UMTS) Terrestrial Radio Access Network (eUTRAN).

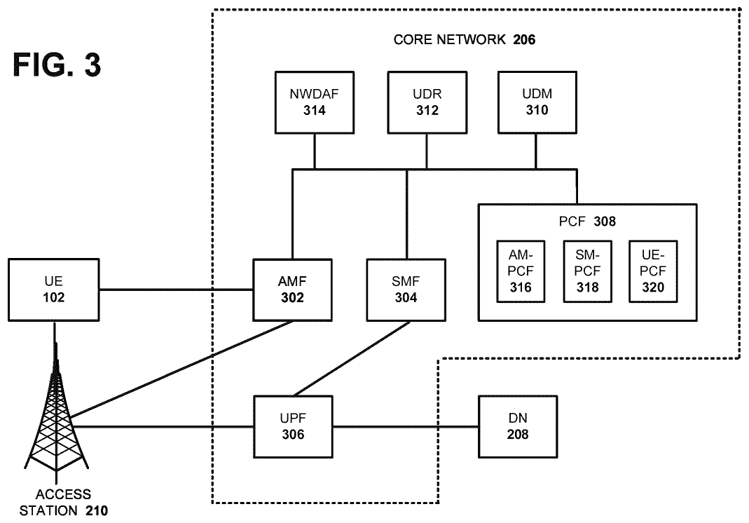

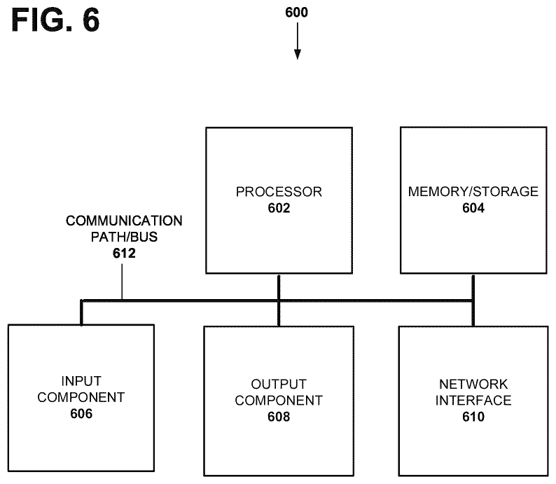

Core network 206 may oversee communication sessions for subscribers connecting via access network 204. For instance, core network 206 may facilitate the establishment of Internet Protocol (IP) connections between UEs 102 and data networks 204. The components within core network 206 can be either dedicated hardware elements or virtualized functions operating atop a shared physical infrastructure using Software Defined Networking (SDN). An SDN controller, for example, may leverage an adapter to implement one or more core network components through virtualized entities like virtual network functions (VNF) virtual machines, Cloud Native Function (CNF) containers, event-driven serverless architecture interfaces, or other SDN components. This shared physical infrastructure may include devices 600, as described below with reference to FIG. 6, within a cloud computing center associated with core network 206. Moreover, core network 206 may encompass 5G core network components, 4G core network components, or other types of components. Further elaboration on some of these components is provided below with reference to FIG. 3.

Core network 206 may include one or more components that implement the systems and methods for granular control over MPS. To provide the MPS to UE 102, when UE 102 registers at core network 206, core network 206 may retrieve a subscription profile that is associated with UE 102 and determine whether UE 102 should receive the MPS based on the subscription profile. If core network 206 determines that UE 102 should receive the MPS, core network 206 may flag or mark its control plane communications among the components of core network 206 (e.g., indicate a high priority in the header of Service Based Interface (SBI) messages). Based on the flag, core network 206 may route all the signaling messages from UE 102 as high priority messages.

As further shown, core network 206 may include one or more network slices 212. Depending on the embodiment, network slices 212 may be implemented within other networks, such as access network 204 and/or data network 208. Access network 204, core network 206, and data networks 208 may include multiple instances of network slices 212 (generically or individually referred to as network slice 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice 212 may be configured to meet a different set of requirements and may be associated with a particular Quality-of-Service (QOS) Class Identifier (QCI), a type of service, a 5G QOS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIOT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAI that identifies the network slice 212.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. In a 5G network, data network 208 that are implemented on network slice 312 may nonetheless be associated with a DNN (e.g., an IMS data network 208 or an Internet data network 208 implemented on network slice 212). Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may render services to other applications running on UEs 102 and may establish communication sessions with UEs 102 via core network 206.

As further shown, one or more data network 208 may include IP Multimedia Service (IMS) network 214. IMS network 214 may deliver multimedia communications services over IP networks. IMS 214 may support a wide range of networks, including fixed and mobile broadband networks. In some implementations, IMS 214 may include Session Initiation Protocol (SIP) networks that play a role in establishing, managing, and terminating multimedia sessions. Such sessions may comprise voice, video, text messages, and other types of multimedia communications across IP networks. When UE 102 that is subscribed to an MPS connects to provider network 104 and then attempts to establish a Protocol Data Unit (PDU) session or a Packet Data Network (PDN) session with IMS network 214, provider network 104 may assign the session a transport priority based on the subscription category associated with UE 102. In some implementations, provider network 104 may take consider the current network conditions, such as network traffic or congestion conditions when determining the priority.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3 depicts exemplary 5G core network components 302-320 in core network 206 according to an implementation. As indicated above, one or more of 5G core network components 302-320, in conjunction with other network components, may implement granular control over MPS. As shown, core network 206 may include Access and Mobility Management Function (AMF) 302, a Session Management Function (SMF) 304, a User Plane Function (UPF) 306, a Policy Control Function (PCF) 308, a Unified Data Management (UDM) 310, a Unified Data Repository (UDR) 312, and a Network Data Analytics Function (NWDAF) 314. Although core network 206 is depicted as including network components 302-320 in FIG. 3, in other implementations, core network 206 may include additional, fewer, and/or different 5G core network components than those illustrated in FIG. 3. For example, core network 206 may further include an Authentication Server Function (AUSF), a Charging Function (CHF), and a Network Slice Selection Function (NSSF).

AMF 302 may perform registration management, connection management, reachability management, mobility management, lawful intercepts, Short Message Service (SMS) transport between UE 102 and a Short Message Service Function (SMSF), session management messages transport between UE 102 and SMF 304, access authentication and authorization, location services management, functionality to support non-Third Generation Partnership Program (3GPP) access networks, and/or other types of management processes.

In some implementations, AMF 302 may include one or more components (e.g., hardware or software components) for granular control of MPS. When AMF 302 receives, from UE 102, a registration request which indicates that UE 102 is subscribed to MPS, AMF 302 may send a request for user/UE profile information to UDM 310/UDR 312. UDM 310/UDR 312 may then respond to the request with subscription data, which may include network slice IDs (e.g., S-NSSAI, NSSAI, network slice instance ID, etc.) of network slices 212 which UE 102 is allowed to access, DNNs that UE 102 may access, and an indication of whether UE 102 is subscribed to an MPS (e.g., the flag MPSPriority is set to “YES” or “Y”). Next, AMF 302 may send a request to AM-PCF 316 to receive policy-related information. The information may include, for example, DNNs and/or network slice IDs to which MPS policy parameters apply and the MPS policy parameters. The MPS policy parameters may include, for example, the MPSPriority flag value and a priority level that is associated with the subscriber category of UE 102 (e.g., MPSPriorityLevel=2).

In some implementations, AMF 302 may also receive analytics information associated with access network 204 and/or core network 206, The analytics information may include key performance indicators (KPIs) and/or other traffic data, such as congestion levels of network slices 212 and data networks 208, latencies at network slices 212 and/or data networks 208, etc. AMF 302 may store the MPS policy information and network analytics data that pertain to the network slices 212 and/or data networks 208 that UE 102 may access.

After the registration, UE 102 may request AMF 302 for a PDU session. In response, as part the process for the session establishment, AMF 302 may obtain the value of a SBI priority based on the following: the DNN (or the network slice ID) of data network 208 (or network slice 212) to which UE 102 is requesting a session, the MPS policy parameters received from AM-PCF 316 (e.g., MPSPriorityLevel values for DNNs/network slices), an indication of the MPS, and/or the network analytics data from NWDAF 314. Subsequently, AMF 302 may request SMF 304 to establish a session for UE 102, conveying the DNN, the network slice ID, and/or the SBI priority level. After the session establishment, UE 102 may receive its service via the session.

SMF 304 may perform session establishment, session modification, and/or session release, perform IP address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate of charging data collection, terminate session management parts of Non-Access Stratum (NAS) messages, perform downlink data notification, manage roaming functionality, and/or perform other types of control plane processes for managing user plane data.

UPF 306 may maintain an anchor point for intra/inter-RAT mobility, maintain an external PDU point of interconnect to a particular data network (e.g., data network 208), perform packet routing and forwarding, perform the user plane part of policy rule enforcement, perform packet inspection, perform lawful intercept, perform traffic usage reporting, perform Quality of Service (QOS) handling in the user plane, perform uplink traffic verification, perform transport level packet marking, perform downlink packet buffering, forward an “end marker” to a RAN node (e.g., access station 210), and/or perform other types of user plane processes.

PCF 308 may support policies to control network behavior, provide policy rules to control plane functions (e.g., to AMF 302, SMF 304, etc.), access subscription information relevant to policy decisions, make policy decisions, and/or perform other types of processes associated with policy enforcement. As further shown, PCF 308 may include an access management (AM)-PCF 316, a session management (SM)-PCF 318, and a UE-PCF 320. AM-PCF 316 may interact with AMF 302 and may provide policies that relate to access and mobility management to AMF 302; SM-PCF 318 may interact with SMF 304 and may provide policies that relate to session management to SMF 304; and UE-PCF 320 may provide policies that relate to handling UE 102.

In some implementations, AM-PCF 316 may receive a request for a policy association from AMF 302. In response, in addition to associating policies with UE 102, AM-PCF 316 may access UDM 310/UDR 312 and lookup subscription data and data that relates to policies on UE 102. For each slice ID of allowed network slices 212 for UE and each DNN that UE 102 may access, AM-PCF 316 may determine an MPSPriority flag value and/or an MPSPriorityLevel based on the subscriber category of UE 102. AM-PCF 316 may provide the MPSPriority and MPSPriorityLevel for each of the DNN and/or network slice to AMF 302.

UDM 310 may maintain subscription information for UEs 202, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store the data that it manages in UDR 312. The subscription data may include information that is associated with the subscribers of UE 102, such as an indication whether UE 102 is subscribed to the MPS. The subscription data may be made available to other NFs via UDM 310. UDR 312 may also include policy data and application data. The policy data may include policy rules and parameters associated with the policy rules. The application data may comprise information and/or data collected by applications.

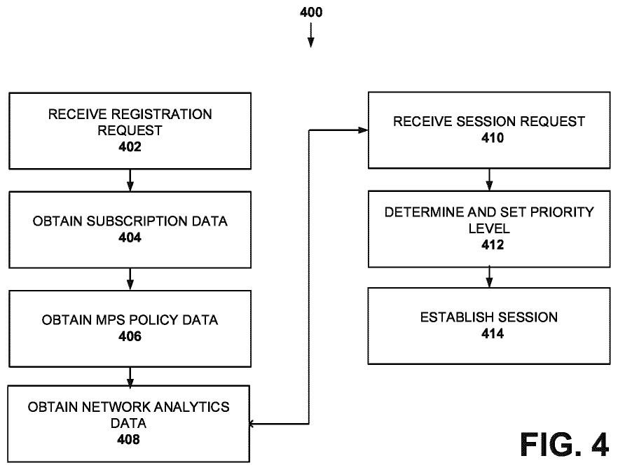

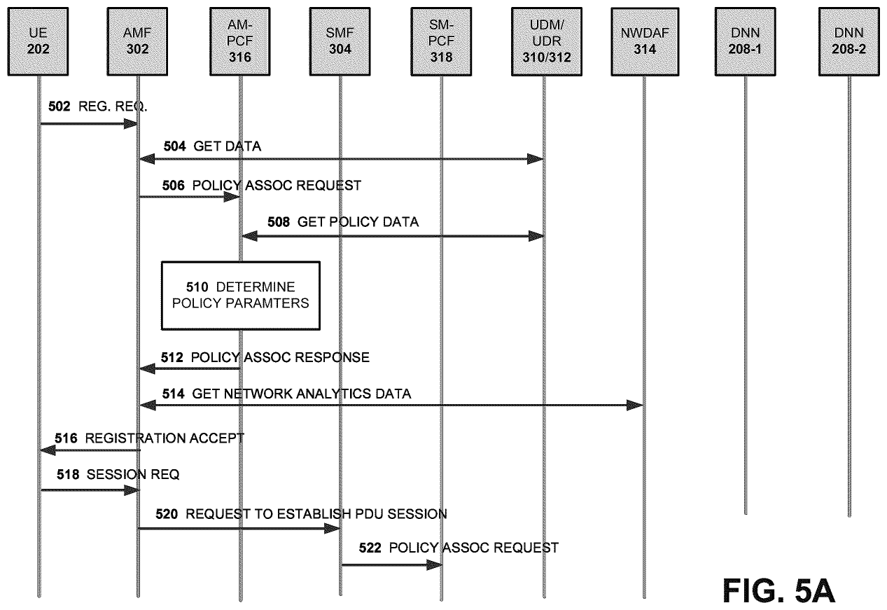

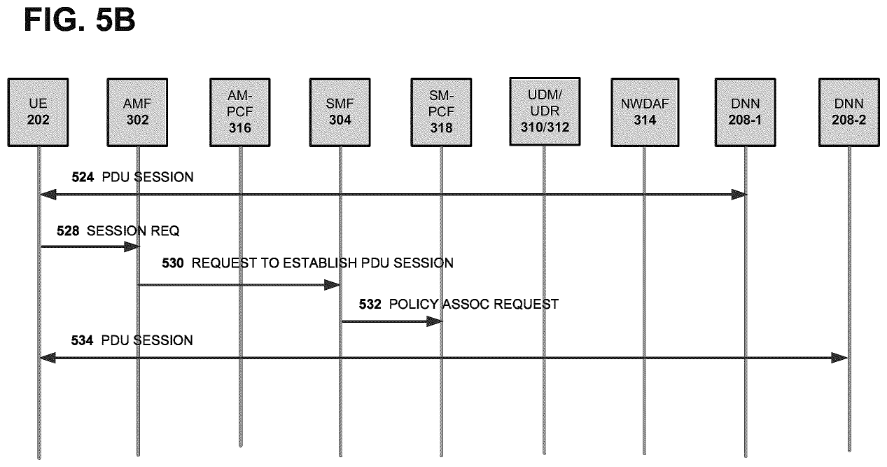

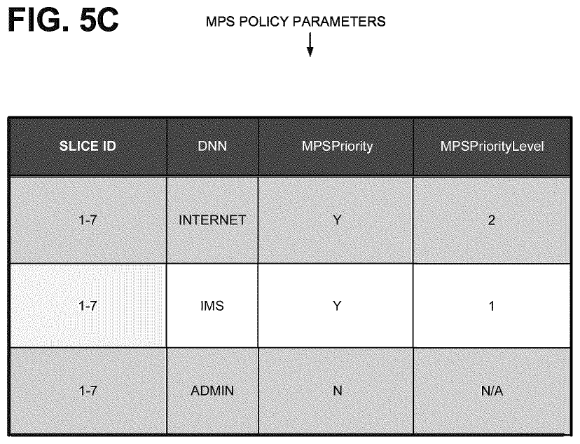

FIG. 4 is a flow diagram of an example process 400 associated with granular control over MPS, according to an implementation. FIGS. 5A and 5B depict example messages that may be exchanged between components 302-320 during process 400. FIGS. 5A and 5B are described below together with process 400. Process 400 may be performed by various components of network 104, including those depicted in FIGS. 1-3. Each block and/or arrow in FIGS. 4. 5A, and 5B is not intended to signify every action performed by the components or every message sent by the components. For example, FIGS. 5A and 5B may not show some actions and/or messages transmitted as replies to queries or messages.

As shown, process 400 may include AMF 302 receiving, from UE 102, a request for registration (block 402) and obtaining subscription information (block 404) which pertains to UE 102 from UDM 310 and/or UDR 312. For example, referring to FIG. 5A, UE 102 may send a registration request to AMF 302 (arrow 502). To register UE 102, AMF 302 may then send a request, for subscription data associated with UE 102, to UDM 310 (arrow 504). The subscription data may include an indication whether UE 102 is subscribed to the MPS (e.g., MPSPriority=Y), as well as IDs of network slices and/or DNNs of data networks 208 which UE 102 may access.

Process 400 may further include AMF 302 obtaining MPS policy data (block 406). For example, AMF 302 may send a policy association request to AM-PCF 316 (arrow 506). In response, AM-PCF 316 may send a request for policy data (e.g., policy data pertaining to UE 102) to UDM 310 (arrow 508). When UDM 310 provides the data, AM-PCF 316 may determine MPS policy parameters (block 510). In particular, for each network slice 212 and data network 208 that UE 102 is allowed to access, AM-PCF 316 may determine MPSPriority (either “YES” or “NO”) and MPSPriorityLevel. AM-PCF 316 may determine the MPS policy parameters based on CHF (which may provide billing/charging information) or/and analytics information from NWDAF 314.

FIG. 5C shows example MPS policy parameters, according to an implementation. As shown, for slice ID=1-7 and the DNN=INTERNET, AM-PCF 316 may determine that MPSPriority=Y and MPSPriorityLevel=2. For slice ID=1-7 and the DNN=IMS, AM-PCF 316 may determine that MPSPriority=Y and MPSPriorityLevel=1. For slice ID=1-7 and the DNN=ADMIN, AM-PCF 316 may determine that MPSPriority=N. AM-PCF 316 may determine the MPS Priority and MPSPriorityLevel (e.g., MPS policy parameters) based on CHF (which may provide billing/charging information) or/and analytics information from NWDAF 314. Next, AM-PCF 316 may send the MPS policy parameters to AMF 302 for each network slice 212 and/or data network 208 which UE 102 may access (arrow 512).

Process 400 may further include AMF 302 obtaining network analytics data (block 408). For example, AMF 302 may obtain network traffic data and KPIs from NWDAF 314 (arrow 514). The network traffic data and the KPIs may include, for example, the volume of traffic at network slices 212 and data networks 208, that UE 102 is allowed access, the latencies of network slices 212 and data networks, and/or other traffic-related tata that indicates the levels of congestion. Next, AMF 302 may complete the registration of UE 102 and send a registration accept response (arrow 516).

Process 400 may further include AMF 302 receiving a request for a session (block 410) from UE 102; determining a priority level for UE 102 (block 412); and setting the priority level for the session (block 412). Continuing with the example for block 408, upon receipt of a session request from UE 102 (arrow 518), AMF 302 may identify a particular network slice or the data network 218 with which UE 102 is requesting the session, based on the DNN or the network slice ID provided in the request. Next, AMF 302 may look up a particular pair of MPSPriority and MPSPriorityLevel for the selected DNN and the network slice ID. Furthermore, based on traffic data, the determined MPSPriority, and the determined MPSPriorityLevel, AMF 302 may determine a priority for messages that core components will exchange to set up a session. For example, for DNN=INTERNET and the MPSPriorityLevel=2, AMF 302 may determine that the SBI-Message-priority=2 for the header of the message to be sent to SMF 304 for setting up the session.

Process 400 may further include completing the establishment of the session (block 414). For example, after selecting the SBI-Message-priority=2, AMF 302 may send a request to establish a session to SMF 304 (arrow 520). The request, which is an SBI message, may carry the SBI-Message priority of 2 in its header. Similarly, additional messages exchanged by components 302-320 to complete the establishment of the session may also carry the SBI-Message-priority of 2, such as a request for policy association (arrow 522). With the exchange of these messages, core components 302-320 may establish the requested session (FIG. 5B; arrow 524).

In the above, by having AM-PCF 316 take into consideration the subscriber category of UE 102, core network components 302-320 may exert granular control over the MPS. In particular, core network components 302-320 may do so by having AM-PCF 316 determine MPS policy parameters based on the subscription category, and then by having AMF 302 select SBI-Message priority based on the MPSPriorityLevel and network traffic conditions. Accordingly, the transport priorities for UEs 102 with a different MPS subscriber category may be different.

In addition, core components 302-320 may also exert granular control over the MPS when UE 102 requests sessions with different network slices 212 or data networks 208. As shown in FIG. 5B, after establishing session 524, UE 102 may request 528 another session but with DNN=IMS. In response to request 528, AMF 302 may select an SBI-Message priority based on the requested DNN (and/or network slice ID) and the network traffic data. Because the DNN=IMS for request 528 is different from DNN=INTERNET for request 518, AMF 302 may select an SBI-Message priority that is different than that for request 518. In particular, AMF 302 may select the SBI-Message priority of 1. Next, AMF 302 may issue a session establishment request 530 that bears the SBI-Message priority of 1 to SMF 304. Additional messages exchanged among components 302-320 to complete the establishment of the session may also carry the SBI-Message-priority of 1, such as a request for policy association (arrow 532). With the exchange of these messages, core components 302-320 may establish the session requested by UE 102.

FIG. 6 depicts exemplary components of a network device 600. Network device 600 may correspond to or be included in any of the devices and/or components illustrated in FIGS. 1, 2, 3A, 3B, 4, and 5 (e.g., network 104, UE 102, access network 204, core network 206, data network 208, access station 210, and core network components 302-320). In some implementations, network devices 600 may be part of a hardware network layer on top of which other network layers and NFs may be implemented.

As shown, network device 600 may include a processor 602, memory/storage 604, input component 606, output component 608, network interface 610, and communication path 612. In different implementations, network device 600 may include additional, fewer, different, or different arrangement of components than the ones illustrated in FIG. 6. For example, network device 600 may include line cards, switch fabrics, modems, etc.

Processor 602 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 600 and/or executing programs/instructions.

Memory/storage 604 may include static memory, such as read only memory (ROM), and/or dynamic memory, such as random access memory (RAM), or onboard cache, for storing data and machine-readable instructions (e.g., programs, scripts, etc.). Memory/storage 604 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 604 may be external to and/or removable from network device 600.

Memory/storage 604 may include, for example, a Universal Serial Bus (USB) memory stick, a dongle, a hard disk, off-line storage, a Blu-Ray® disk (BD), etc. Memory/storage 604 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 606 and output component 608 may provide input and output from/to a user to/from network device 600. Input/output components 606 and 608 may include a display screen, a keyboard, a mouse, a speaker, a microphone, a camera, a DVD reader, USB lines, and/or other types of components for obtaining, from physical events or phenomena, to and/or from signals that pertain to network device 600.

Network interface 610 may include a transceiver (e.g., a transmitter and a receiver) for network device 610 to communicate with other devices and/or systems. For example, via network interface 610, network device 600 may communicate over a network, such as the Internet, an intranet, cellular, a terrestrial wireless network (e.g., a WLAN, WIFI, WIMAX, etc.), a satellite-based network, optical network, etc. Network interface 610 may include a modem, an Ethernet interface to a LAN, and/or an interface/connection for connecting network device 600 to other devices (e.g., a Bluetooth interface).

Communication path or bus 612 may provide an interface through which components of network device 600 can communicate with one another.

Network device 600 may perform the operations described herein in response to processor 602 executing software instructions stored in a non-transient computer-readable medium, such as memory/storage 604. The software instructions may be read into memory/storage 604 from another computer-readable medium or from another device via network interface 610. The software instructions stored in memory/storage 604, when executed by processor 602, may cause processor 602 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 4, 5A, and 5B. the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

As used above, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

In addition, the term “(PDU session (a protocol data unit session) or a PDN session (packet data unit session) may refer to communications between a mobile device and another endpoint (e.g., a data network, a network slice, etc.). Depending on the context, the term “session” may refer to a PDU session, a PDN session, or a session between applications. Additionally, depending on the context, the term “connection” may refer to a session, a PDU session, a PDU session, or another type of connection (e.g., a radio frequency link between a device and a base station).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
receive, from a User Equipment device (UE), a registration request;
obtain Multimedia Priority Service (MPS) policy parameters for the UE in response to the registration request;
receive, from the UE, a request to establish a session;
set a priority of a message to be sent to establish the session, based on the MPS policy parameters; and
send the message to establish the session.

2. The device of claim 1, wherein when the processor obtains the MPS policy parameters, the processor is configured to:
obtain an indication of whether the UE is subscribed to an MPS; and
obtain a priority level associated with the MPS.

3. The device of claim 1, wherein when the processor obtains the MPS policy parameters, the processor is configured to:
obtain the MPS policy parameters for each network slice and data network that the UE is allowed to access.

4. The device of claim 3, wherein when the processor obtains the MPS policy parameters, the processor is configured to:
send a policy association request to an Access Management (AM)-Policy Control Function (PCF); and
receive the MPS policy parameters from the AM-PCF.

5. The device of claim 4, wherein the AM-PCF is configured to:
send a subscription data request to a Unified Data Management (UDM); and
receive subscription data from the UDM, wherein the subscription data includes a subscriber category for the UE.

6. The device of claim 1, wherein the device comprises an Access and Mobility Management Function (AMF), and wherein when the processor sends the message, the processor is configured to:
send the message to establish the session to a Session Management Function (SMF).

7. The device of claim 1, wherein the processor is further configured to:
receive network analytics data from a Network Analytics Data Function (NWDAF), and
wherein when the processor sets the priority of the message, the processor is configured to select the priority based on the MPS policy parameters and the network analytics data.

8. The device of claim 1, wherein the message includes a Service-Based Interface (SBI) header that indicates the priority.

9. The device of claim 1, wherein the processor is further configured to:
send a subscription data request to a Unified Data Management (UDM); and
receive subscription data from the UDM, where the subscription data includes an indication of whether the UE is subscribed to an MPS.

10. A method comprising:
receiving, from a User Equipment device (UE), a registration request;
obtaining Multimedia Priority Service (MPS) policy parameters for the UE in response to the registration request;
receiving, from the UE, a request to establish a session;
setting a priority of a message to be sent to establish the session, based on the MPS policy parameters; and
sending the message to establish the session.

11. The method of claim 10, wherein obtaining the MPS policy parameters comprises:
obtaining an indication of whether the UE is subscribed to an MPS; and
obtaining a priority level associated with the MPS.

12. The method of claim 10, wherein obtaining the MPS policy parameters comprises:
obtaining the MPS policy parameters for each network slice and data network that the UE is allowed to access.

13. The method of claim 12, wherein obtaining the MPS policy parameters comprises:
sending a policy association request to an Access Management (AM)-Policy Control Function (PCF); and
receiving the MPS policy parameters from the AM-PCF.

14. The method of claim 13, further comprising:
sending, by AM-PCF, a subscription data request to a Unified Data Management (UDM); and
receiving, by the AM-PCF, subscription data from the UDM, wherein the subscription data includes a subscriber category for the UE.

15. The method of claim 10, wherein sending the message includes:
sending the message to establish the session to a Session Management Function (SMF).

16. The method of claim 10, further comprising:
receiving network analytics data from a Network Analytics Data Function (NWDAF),
wherein setting the priority of the message includes:
selecting the priority based on the MPS policy parameters and the network analytics data.

17. The method of claim 10, wherein the message includes a Service-Based Interface (SBI) header that indicates the priority.

18. The method of claim 10, further comprising:
sending a subscription data request to a Unified Data Management (UDM); and
receiving subscription data from the UDM, where the subscription data includes an indication of whether the UE is subscribed to an MPS.

19. A non-transitory computer-readable medium comprising processor-executable instructions, which when executed by a processor, cause the processor to:
receive, from a User Equipment device (UE), a registration request;
obtain Multimedia Priority Service (MPS) policy parameters for the UE in response to the registration request;
receive, from the UE, a request to establish a session;
set a priority of a message to be sent to establish the session, based on the MPS policy parameters; and
send the message to establish the session.

20. The non-transitory computer-readable medium of claim 19, wherein when the processor obtains the MPS policy parameters, the processor is configured to:
obtain an indication of whether the UE is subscribed to an MPS; and
obtain a priority level associated with the MPS.
